(19) United States
(12) Patent Application Publication
(10) Pub. No.: US 2009/0138414 A1
(43) Pub. Date: May 28, 2009

(54) LIMITED LIABILITY BANKING STRUCTURE INVOLVING MEMBER BANKING AND METHOD OF USE

(76) Inventor: DOUGLAS M. DURBANO, Layton, UT (US)

Correspondence Address: Workman Nydegger;1000 Eagle Gate Tower, 60 East South Temple, Salt Lake City, UT, 84111, US

(21) Appl. No.: 12/324,419

(22) Filed: Nov. 26, 2008

Related U.S. Application Data
(63) Continuation of application No. 10/700,067, filed on Nov. 3, 2003, now abandoned.
(60) Provisional application No. 60/423,181, filed on Nov. 1, 2002.

(51) Int. Cl. G06Q 90/00

(52) U.S. Cl. 705/500

(57) ABSTRACT

A limited liability banking structure and method of use, wherein individual depositors or customer/owners, collectively referred to as “members,” may share in the profits and losses of the bank in order to stimulate deposits or capital raising, and still enjoy the benefits of limited individual liability and partnership taxation. Various classes of members offer a variety of associated, but unique, benefits including the pass through of certain profits or tax losses. The banking entity profits are not taxed at the entity level, but only as such profits are passed through to its various classes of members.

### PRIORITY INFORMATION

This application is a continuation of prior application Ser. No. 10/700,067 filed Nov. 3, 2003, entitled “Limited Liability Banking Structure Involving Member Banking and Method of Use”, which claims the benefit of United States Provisional application filed Nov. 1, 2002, entitled “A Method for Member Banking, Ser. No. 60/423,181. Both of the foregoing applications are incorporated by reference in their entirety.

### FIELD OF THE INVENTION

The present invention relates generally to a method of banking. Specifically, the present invention provides for a limited liability banking structure within which a bank may operate and be taxed, and wherein businesses or individuals may become members of the banking organization and may participate in profit sharing and other membership benefits.

### BACKGROUND

### Background and Relevant Art

There are two general types of banking institutions commonly recognized today: commercial banks and federal savings banks. Among the more widely utilized commercial banks, the two basic bank types are state chartered banks, which are regulated primarily by the Federal Deposit Insurance Corporation (“FDIC”), and nationally chartered banks, primarily regulated by the Office of the Comptroller of the Currency (“OCC”). State chartered banks may elect to become members of the Federal Reserve, thereby becoming member banks-a designation to be distinguished from the term “Member Banking” as defined uniquely below.

Commercial banks engage in a broad cross-section of activity including, but not limited to, business, real estate, and consumer lending. By comparison, federal savings banks, as chartered and regulated by the federal government, are less common, which is due in part to the significant reduction in the existence of Savings and Loan (“S&L”) banks after their demise during the 1980's. Federal savings banks engage primarily in single-family residential and commercial real estate lending.

In terms of corporate structure, most commercial and federal savings banks are structured as C-Corporations (“C-Corp”) for the purpose of raising money on the public market; however, some banks are also organized as S-Corporations (“S-Corp”), which cannot maintain more than seventy-five shareholders at any given time. Both of these types of entities are integrally linked to their respective methods of banking. Although generally effective in attracting market capital, both types of entities are often unresponsive to individual depositors' needs and/or desires, and are subject to undesirable tax treatment. More specifically, corporations are subject to dual taxation, first as an entity, and second as individual taxpayers. Under typical C-Corp or S-Corp status, banks share their profits with shareholders according to a particular shareholder's percentage ownership, or number of shares. Management of these entities is typically controlled primarily by a board of directors as elected by the shareholders.

Over the last fifteen years, the number of commercial banks in the United States has dropped due primarily to bank mergers. In 1990, there were 12,347 banks compared to 8,315 in 2000. The total continued to decline to 7,887 at year-end 2002. As the consolidation of the nations banks was underway, the number of bank branches in the United States increased from 50,406 in 1990, to 64,079 in 2000, and 66,185 branches during the period of economic recession between 2000 and 2002. During that period between 2000 and 2002, the number of bank offices also increased from 72,394 to 74,072.

During this period of bank mergers and economic ups and downs, total bank assets, bank loans and leases, and deposits showed impressive growth. Total bank assets were $3,389 billion, $6,244 billion, and $7,077 billion at then end of years 1990, 2000, and 2002, respectively. Net bank loans and leases increased from $2,110 billion, to $3,755 billion, to $4,082 billion over the same year-ends. Total bank deposits in the United States were $2,650 billion at the end of 1990, $4,180 billion at the end of 2000, and $4,690 billion at the end of 2002.

Total interest income has shown fluctuations and modest growth since 1990. Total interest income for banks in the United States was $320 billion, $428 billion, and $358 billion in 1990, 2000, and 2002, respectively. For the same periods, non-interest income increased more than 300% from $55 billion, to $153 billion, to $172 billion. Additionally, net income experienced more than a five-fold increase, jumping from $16 billion in 1990, to $71 billion in 2000, to a record $90 billion in 2002.

In contrast, other banking methods, typically utilized by banking cooperatives and credit unions for example, often organize as not-for-profit entities in order to receive certain preferential tax treatment and to offer banking incentives to their depositors rather than a share of profits. For many cooperatives and credit unions, because profit sharing is not an option available to their depositors, incentives are often offered to depositors in the form of reduced interest rates or other services and/or discounts. In terms of management, these entities are often controlled by an elected board of directors, or by a collective body of customer/owners. Customer/owners are often called “Members.”

Credit unions are closely regulated by, and operate under the direction of, the National Credit Union Share Insurance Fund, as administered by the National Credit Union Administration. This agency of the federal government insures deposits of credit union members. Although credit unions offer membership benefits, they often struggle with raising capital because there are no profit sharing options for members and, consequently, little incentive for members to contribute capital to the financial institution. Despite these disadvantages, credit unions have shown significant growth in the last twenty years. Reasons for their expansion are many.

First, credit unions are non-profit non-taxed entities. Elimination of tax obligations allows credit unions to charge less for their services, to lower rates on their loans, and to increase rates on their savings and deposit instruments. Second, credit union customers are “members” and have “ownership” in their “banking” institution through their savings deposits. This ownership leads to an establishment of loyalty on the part of their members, a loyalty unmatched by the bank-customer relationship. Third, credit unions are perceived by their members as “local businesses”. In today's world of diminishing personal contact between businesses and their customers, this perception provides a genuine advantage to the credit union method of banking since most have a limited geographical distribution.

Despite a general expanding trend over the last twenty years, the number of credit union in the United States has also decreased due primarily to mergers. In 1990, there were 14,459 credit unions compared to 10,684 in 2000. The total continued to decline to 10,041 at year-end 2002. The 2002 total included 5,950 federal credit unions and 4,091 state credit unions. During this fifteen-year period, total credit union assets, loans and leases, and savings have shown continued growth. Total credit assets were $217 billion, $450 billion, and $575 billion at then end of years 1990, 2000, and 2002, respectively. Net credit union loans increased from $139 billion, to $309 billion, to $355 billion over the same year-ends. Total savings (including shares and drafts) in U.S. credit unions were $197 billion at the end of 1990, $390 billion at the end of 2000, and $500 billion at the end of 2002. Net equity totaled $17 billion, $51 billion, and $62 billion for the years ending 1990, 2000, and 2002, respectively.

While the panorama of company structures is available to most industries in the United States, to date, banks have not used the limited liability company (“LLC”) as a corporate organizational vehicle. Interestingly, corporate law and banking regulations do not exclude banks from this particular option. However, no bank has opted to organize as an LLC take advantage of its tax pass through status.

Recently, the FDIC, the insuring agency for the nation's banks, was approached regarding the viability of incorporating a bank as an limited liability company. The response by the FDIC was that while an LLC had not previously been used in conjunction with banking organizations, there was no legal or regulatory prohibition against its use. The FDIC then indicated that a banking institution could use an LLC.

It is hereby noted that, with regard to what is known in the prior art, it would be advantageous to provide an FDIC insured banking structure and method of use, wherein individual depositors or customer/owners, collectively referred to as “Members,” may share in the profits and losses of the bank in order to stimulate deposits or capital raising, and still enjoy the benefits of limited individual liability and partnership taxation. The overall company objectives may include: 1) the creation of a unique banking institution that utilizes an FDIC insured LLC as the instrument of incorporation; 2) the distribution of a portion of the banking institution's profits to local bank founders and key business members; 3) the maintaining of pass through tax status of the company and its subsidiaries; and 4) the raising of capital from individuals and businesses, outside of the traditional public security markets.

### SUMMARY OF THE INVENTION

The present invention relates generally to a method of banking. Specifically, the present invention provides for a limited liability banking structure within which a bank may operate and be taxed, and wherein businesses or individuals may become members of the banking organization and may participate in profit sharing and other membership benefits.

The present invention may be viewed as a method of forming and utilizing a limited liability organization that is used in the typical environment in which banks, or other banking entities, such as credit unions or banking cooperatives, are employed to receive federally insured deposits, service loans, manage investments, and conduct related financial transactions, but where it may be advantageous to allow bank members and owners to share in the profits and losses of the bank. Further, the present structure and method provides that profits are only taxed once at the member level, similar to a partnership structure but with limited liability or no pass-through liabilities to the member or owner.

The advantages over prior art may lie principally in that the present structure and method accomplishes the aforementioned tasks by maintaining a parent holding company, organized as a LLC, for the management, investment, and general ownership of the FDIC insured banking entity, and where each branch, or local bank, is a wholly owned subsidiary LLC of the parent holding company. Further, local branches or banks may be viewed as extensions of the FDIC insured banking entity, endowing full rights of bank membership to local branch members who receive pass-through profits, but with limited liability. As LLC's, the banking institutions would not be taxed and would forward earnings and tax obligations to the bank owners. Without the tax obligation, the banking company would potentially stand on equal footing with credit unions, if only in relation to the credit union's non-profit/tax free status.

The local branches or subsidiary LLC banks may be viewed as “franchise banks”. Over the last twenty years, the number of banking corporations has sharply declined. While there are more bank branches and offices than ever before, these are part of larger and larger corporate institutions. At the same time, the cost of starting new banks and the regulatory load placed on all banking institutions make it extremely difficult to successfully launch new banks. It is estimated that the minimum capital required to fund a new bank now exceeds $5 million. This single requirement makes it prohibitive for many potential investors to embark in a banking enterprise. The intent of the bank holding company is to provide a unique banking structure that will assist investors in local communities to successfully start up and operate community-based banking institutions. The present method includes the above stated advantages of an LLC, along with access to a bank charter, FDIC insurance, and an operating model.

Another objective of the present method is to create an environment in which bank business customers can become member-partners in the business. This is achieved by establishing preferred member accounts with minimum deposit amounts. The initial deposit entitles bank business customers to become member-partners in the local banking company. Membership in the local bank will give the business member-partner access to preferred services and rates. The member-partner will also receive a distribution of the local banks earnings, based on a formula relating to average deposits held by the bank, interest and fees earned by the bank, and business referred to the bank by the member-partner.

In addition to business-members, other individual customers, or members, will also be part of the bank's marketing effort. While these individual members receive a nominal distribution of their local banks earnings, they will be able to take advantage of lower rates generated by the pass through taxing advantages of the LLC bank.

A further aspect of the present method is that a mechanism will be in place for the distribution of a portion of earnings to the founders, or initial investors, of the bank. As previously stated, the ability to distribute earnings to investors is a distinct advantage an LLC bank would have over a credit union.

Additional features and advantages of the invention will be set forth in the detailed description which follows, taken in conjunction with the accompanying drawings, which together illustrate by way of example, the features of the invention.

### BRIEF DESCRIPTION OF THE DRAWINGS

The present structure and method consists in the novel combination of parts hereinafter more fully described, wherein like numbers correspond to like elements between the appended drawings, as illustrated and claimed. Further, there is shown in the drawings an embodiment which is presently preferred, it being understood however, that the invention is not limited to the exact form as shown herein. A brief description of the drawings is as follows:

FIG. 1 is a chart of an illustrated embodiment of a structure of the present system of member banking 10;

FIG. 2 is a chart of an illustrated embodiment of a holding company 12 of the present system of member banking 10 of FIG. 1;

FIG. 3 is a chart of an illustrated embodiment of a chartered bank 14 of the present system of member banking 10 of FIG. 1; and

FIG. 4 is a chart of an illustrated embodiment of a franchise bank 16 of the present system of member banking 10 of FIG. 1.

### DETAILED DESCRIPTION OF THE ILLUSTRATED EMBODIMENT(S)

For the purposes of promoting an understanding of the principles of the present invention, reference will now be made to the exemplary embodiments illustrated in the drawings, and specific language will be used to describe the same. It will nevertheless be understood that no limitation of the scope of the invention is hereby intended. Any additional features, alterations, further modifications, or equivalents of the inventive features illustrated herein, and any additional applications of the principles of the invention as illustrated herein, which would occur to one skilled in the relevant art, having possession of this disclosure, are to be considered within the scope of the present invention.

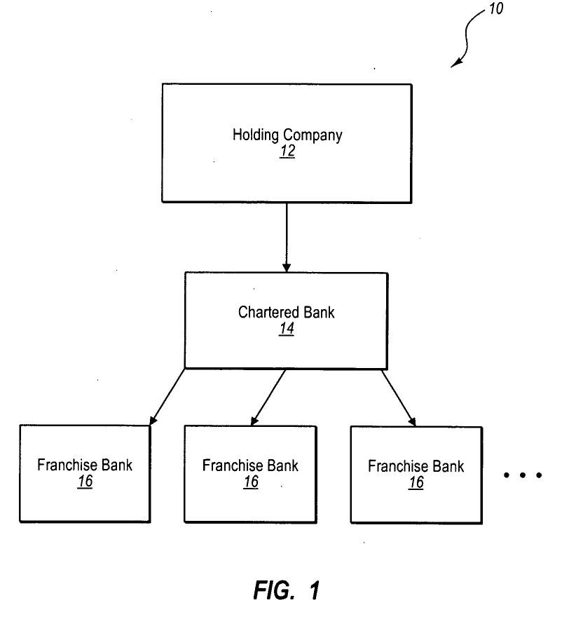

Referring now to FIG. 1, there is shown a chart of an illustrated embodiment of the method of member banking 10. Specifically, there is illustrated a structure for the present system of member banking 10 that includes the formation of a holding company 12, organized as an LLC to own, manage, assist, build, support, and direct an FDIC insured chartered bank 14 and multiple franchise banks 16 in various locales. The franchise banks 16 may also be FDIC insured, and are organized as LLC'S.

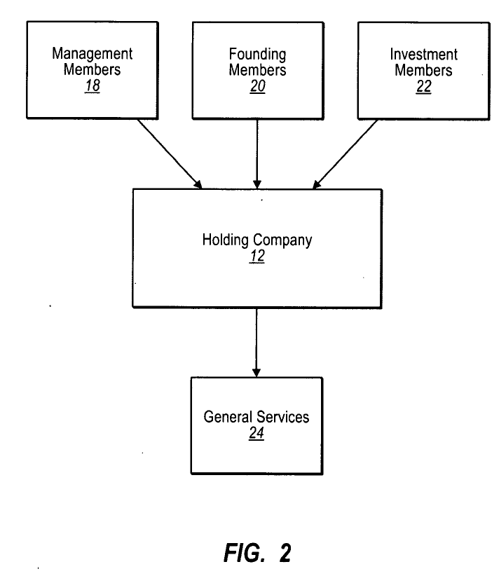

Now referring to FIG. 2, there is shown a chart of an illustrated embodiment of the holding company 12, along with membership composition and services provided. The holding company 12 may consist of a multi-member board of managers, including management members 18, founding members 20, and/or investment members 22. The role of the investment members 22, who may also serve on the multi-member board of managers if elected, is to provide capital, typically in the form of liquid or non-liquid assets. Further the investment member class may include miscellaneous investors to the holding company 12. The role of management members 18, who may also serve on the multi-member board of managers if elected, is to provide management services to the holding company 12, typically in the form of knowledge and/or experience. More specifically, the management member 18 class may include any initial investors into the holding company 12 who provided, or helped to provide, the initial concept and initial capital. The role of founding members 20, is to provide capital and other investment as required to begin banks in various locales. This may include founding members of localized franchise banks 16, identified as “franchise founding members”, as further defined below.

A board of directors (the “Board”), including seven members, is designated to lead the holding company 12. Members of the board may include individuals with corporate management responsibility as well as independent parties from outside the holding company 12. Further, the holding company 12 is the mechanism to implement franchise banking and member banking concepts. A general objective of the holding company 12 is to build local and regional franchise banks 16, where locally oriented individuals will be essential to bringing franchise banks 14 into their communities. These individuals may become a source of capital, as well as a direct connection with the community as a whole.

FIG. 2 also illustrates a representative set of general services 24, as provided by the holding company 12 including, but not limited to, loan sourcing services, marketing services, mortgage services, insurance services, property management services, equipment leasing services, consulting services, mutual find management services, and travel agency services for the subsidiary franchise banks 16. The general purpose of the holding company 12 in offering these services to franchise banks 16 is to: provide regulatory oversight, thereby ensuring safe and sound banking practices; decrease the workload of the franchise banks 16 by instituting routine and systemized procedures; and increase the ease of successfully establishing and operating the franchise banks 16 in a uniformally safe and sound manner by offering similar services and products.

FIG. 2 also illustrates a general method of utilizing an FDIC insured limited liability banking structure, wherein: a holding company 12 may be organized as an LLC; at least one subsidiary franchise bank 16 may be created, owned, and managed by the holding company 12; at least one management member 18 may be designated for contributing capital, making deposits, and engaging in management of the holding company 12 and subsidiary franchise bank 16; at least one investment member 22 may be designated for contributing capital and making deposits to the holding company 12; and at least one founding member 20 may be designated or recognized as having contributed to the initial concept or capital required to initiate the present system and method 10.

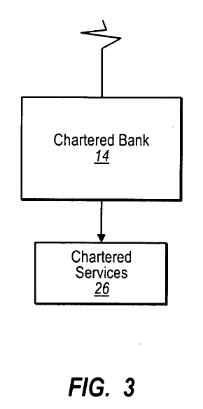

Referring now to FIG. 3, there is shown a representative diagram of an illustrated embodiment of the chartered bank 14. The chartered bank 14 is organized as a hub, or interface, between the holding company 12 and the franchise banks 16. The chartered bank 14 is a wholly owned LLC subsidiary of the holding company 12, and is designed to provide the franchise banks 16 with access to a bank charter. The chartered bank may perform the following charter services 26, not in limitation: consolidating bank accounting information; reporting to regulatory agencies; providing the model or template “look and feel” for the franchise banking units associated with it; providing marketing and advertising services; providing back room support; providing human resources and human resources management; performing audit support functions; providing payroll services; coordinating and providing legal and accounting support; providing and managing information technology hardware and software; and providing personnel training and related services.

The chartered bank 14 may also, in addition to the services outlined above, fulfill a role of providing a template, that essentially functions as a fully expanded business plan, for the franchise banks 16 to follow. The template would include, but is not limited to including: strict timeline/schedule for the start-up of the franchise bank; initial capital available to complete all aspects of the start-up; selection of, and agreement with, franchise founding members 30 who may be involved in management and success of the franchise bank 16; completion of all regulatory applications and receipt of regulatory approval; selection of bank location; setup of bank infrastructure; and formation of goals and objectives formalized for the franchise bank's first year of activity. This role may be facilitated by providing a standard operations manual, including company wide practices and procedures, as well as a system for timely consolidation of bank accounting information to insure company success and meet regulatory requirements. In addition, an ongoing review process of all aspects of the company may be established to insure that goals and budgets are being met and that revisions and adjustments are made as required.

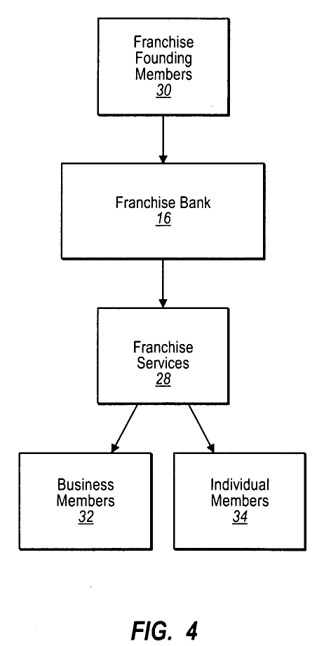

Referring now to FIG. 4, there is shown a representative diagram of an illustrated embodiment of a representative franchise bank 16. The franchise bank 16 is a separate banking unit and is also organized as an LLC. Its stock may be held solely by the holding company 12. For regulatory purposes, the franchise bank 16 acts as a branch of the chartered bank 14.

In terms of membership, the franchise bank 16 may be initially comprised of franchise founding members 30. The franchise founding members 30, who may also be members of the founding members 20 for the holding company 12, typically involve a group of investors in a local community. These investors serve as the franchise founding members 30 of the local bank and will become a part of the franchise bank's advisory board. They will not typically have personal liability for any potential losses of the franchise bank. The franchise founding members may generate a portion of the capital necessary to start the new bank. While the figure is substantial, about $2 million, it is less than half the typical amount required by regulatory agencies to begin a stand-alone bank enterprise. The franchise founding members 30 would also forgo the regulatory travails new banking organizations encounter as they go through the initial de novo probationary period. These franchise founding members 30 may also receive shares in the holding company 12 and may receive a distribution of earnings based on the performance of their franchise bank 16.

More specifically, the role of the franchise founding members 30 may generally be: to contribute capital and accept a proportional risk of loss as well as a pro rata distribution of local profits; to elect board members; and to vote to distribute some portion of local profits to business and individual members 32, 34 based upon their yearly average balances in their respective membership accounts. Business members 32, may participate in the management of the franchise bank 16 by electing board members according to a one vote per member/account schedule, may make deposits classified as business members into interest bearing accounts, and may receive yearly distributions of profits according to a measure of their account activity, account balance, interest paid, volume deposits, or a similar index. Finally, individual members 32 may participate in management by electing board members according to a one vote per member/account schedule, may make deposits classified as individuals, and may receive yearly distributions of profits according to a measure of their account activity, account balance, interest paid, volume deposits, or a similar index.

The franchise bank's advisory board is invited to include seven individuals. Three board members may come from the founding members of the bank 20, with one representative pulled from the holding company 12, one representative from the charter bank 14, and two representatives from the bank's member-partner group, drawn from business members 32 or individual members 34.

In relation to size, it is important that the franchise bank 16 is perceived as a local, community bank, but large enough too attract the premier business customers in the area. Personal liability for banking operations will be with the board members of the chartered bank 14. These individuals must, with the help of the franchise bank advisory board, be intimately involved in the franchise bank's decisions.

The business model for franchise banks 16 may be based on the pattern envisioned by the holding company 12 and the chartered bank 14. The customers of the bank may be comprised of business members 32 and individual members 34. The pass through tax status of the LLC will allow the franchise bank 16 to compete favorably with the other area banks and against non-profit credit unions. The member status of depositors who may share in profit distributions, the community-based advisory board, and the wide variety of banking products available are projected to stimulate strong, local customer loyalty.

As for specific services that participating franchise banks 16 may provide, the following list is provided for illustration only, not in limitation: convenient operating hours; personal relationship banking; on-line banking; 24-hour account access by telephone; direct deposits; wire transfer services; safe deposit boxes in all sizes; cashier's checks; utility payment program; special credit card services for students (no credit required); postage stamps; utility payment drop box; overdraft protection; bounce protection; free medallion stock guarantee service; notary services; money orders; 24-hour drive-up ATMs at all locations; Visam and MasterCard™ program; checking accounts; savings accounts; and a myriad of loans.

### REMARKS REGARDING THE ILLUSTRATED EMBODIMENT(S)

In general reference to the drawings as considered in their entirety, the present structure creates a banking entity structure, with a corresponding method of use, which is organized under state law either through its holding company, the bank itself, or both, as a federally insured LLC. Under this form, owners may be referred to, or defined, as members with all profits and losses passing through to the owners under a partnership, or one-time, taxation scheme. Therefore, a unique banking entity may be organized whereby owners become profit sharing members, in contrast to traditional shareholders.

This unique system of allowing customers to become profit sharing members, as referred to herein as members of the bank or financial institution in which they participate, is a primary tenet of the “member banking” method. This allows typical FDIC insured depository institutions, commonly referred to as banks, to adopt the attributes of common credit unions or cooperatives. In particular, the member bank may be owned and managed by its members who are also bank customers. In contrast to a credit union, which is a nonprofit organization, the members of the bank would receive an actual distribution of a portion of the bank's profits, based upon the definition of the various class of members into which the particular individual or business may belong.

It is perceived that the general benefits of the present system and method over the prior art include, but are limited to, the following when considered individually or in combination: a unique corporate banking structure, namely the limited liability organization; pass through tax capability; a member-based ownership and reward structure; an ability to make local credit decisions; highly committed and experienced employees; a unique banking atmosphere based on commitment to business and individual members, who are treated like owners; an ability to build banking units within an existing corporate structure, thereby eliminating the need to start from the ground up as a typical banking entity; an ability of the charter and franchise banks to offer FDIC protection; and an ability of the holding company to offer a multitude of varying business services, including potential acquisitions of banks, credit unions, and other businesses.

### DESCRIPTION OF TERMINOLOGY

The following is a brief description, or definition, of terms as uniquely understood in relation to the present structure and method for member banking. Various classes of owners or shareholders may have distinct designations. First, there is a broad class involving all owners that would be generally referred to as “members”. Second, there is a more specific class called “management members” which refers to those members involved in bank management. Third, another class is for “founding members”, or those members involved in the initial founding of the banking entity. Fourth, there is a more specific class called “investment members” which refers to those members involved generally with contributions of various forms. Fifth, there are “franchise founding members” who may be involved with contributing time, talent, and capital to the organization of the franchise banks, or of the general founding of the holding company and chartered bank. On the customer side, “business members” may be generally used to designate those members that independently qualify as businesses. Finally, and without limitation, there may be an “individual members” class for those members qualifying as individuals.

### VARIATIONS OF THE ILLUSTRATED EMBODIMENT(S)

It is understood that the arrangements described above are only illustrative of the application of the principles of the present invention. Numerous modifications and alternative arrangements may be devised by those skilled in the art without departing from the spirit and scope of the present invention, and the appended claims are intended to cover such modifications and arrangements.

For example, in addition to the illustrated banking structure, it is noted that the set of general services provided by the holding company may be expanded to include additional services such as technical support, software management, or property leasing and maintenance. Alternatively, the holding company may be contracted to engage in only one, or no additional service(s). The franchise banks may be required to carry out a wide array of similar services depending on the number and nature of specific services allocated to the holding company.

The use of multiple holding companies and chartered banks are also contemplated. In contrast to maintaining a single holding company organized as an LLC, multiple holding companies and chartered banks, which are organized to manage and own subsidiary franchise banks in diverse locations, are also contemplated as falling within the scope of the present invention.

Another variation of the present system and method is that an internal audit procedure may be incorporated into all company levels. Additions to the number and nature of classes of members are also contemplated. For example, there may be added a simplified class of members, who may share in a limited amount of profits, who may have limited voting powers, and/or who may share in a diminished risk of loss.

What is claimed is:

1. A method of forming a FDIC insured banking structure that utilizes a multi-class layered limited liability organization having a pass through tax status and in such a manner as to enable profits and losses to pass through to owners under a partnership scheme and while at the same time enabling banking customers to become profit sharing members that also participate in ownership and management of the banking structure, the method comprising:
organizing a bank holding company that is designated as a limited liability company;
organizing at least one franchise bank which is FDIC insured and organized as a limited liability company and which is wholly owned and managed by the bank holding company, the at least one franchise bank being organized in such a manner as to provide banking services to customers comprising franchise bank members, wherein profit sharing distributions are made to the franchise bank members and wherein at least some of the franchise bank members are enabled to participate in management of the at least one franchise bank; and
organizing a chartered bank which is FDIC insured and organized as a limited liability company and which is wholly owned and managed by the bank holding company, the chartered bank being organized in such a manner as to provide charter services to the at least one franchise bank and to provide an interface between the at least one franchise bank and the bank holding company.

2. The method recited in claim 1, wherein the bank holding company provides services to the at least one franchise bank, the services provided including at least one of:
loan sourcing services,
marketing services,
mortgage services,
insurance services,
property management services,
equipment leasing services,
mutual fund management services, or
consulting services.

3. The method recited in claim 2, wherein the services provided include:
the loan sourcing services,
the marketing services,
the mortgage services,
the insurance services,
the property management services,
the equipment leasing services,
the mutual fund management services, and
the consulting services.

4. The method recited in claim 1, wherein the charter services provided to the at least one franchise bank include:
consolidating bank accounting information for the at least one franchise bank;
reporting to regulatory agencies for the at least one franchise bank;
providing a template defining a look and feel for the at least one franchise bank;
providing marketing and advertising services, human resource management, audit support, payroll services, legal and accounting support to the at least one franchise bank; and
providing hardware and software to the at least one franchise bank.

5. The method recited in claim 4, wherein the template defines a strict timeline for the following:
start-up of the at least one franchise bank,
completion of initial capital requirements,
selection of management of the franchise bank,
completion of regulatory applications,
selection of bank location, and
setup of bank infrastructure and formation of goals.

6. The method recited in claim 1, wherein the franchise bank members include preferred members as well as other members, wherein the preferred members are members having minimum account balances with the at least one franchise bank and that receive preferred rates and distributions of earnings based on a formula of deposits and other banking use or activities at least one franchise bank, and wherein the other members receive a nominal distribution of earnings based on earnings of the at least one franchise bank.

7. The method recited in claim 1, wherein organizing the bank holding company includes organizing a multi-member board of managers, including management members, founding members and investment members, wherein the investment members provide capital in the form of assets, the management members providing management services to the bank holding company in the form of knowledge and experience, and the founding members providing capital and investment into one or more of the at least one franchise banks.

8. The method recited in claim 7, wherein the assets comprise liquid assets.

9. The method recited in claim 7, wherein organizing the bank holding company further includes establishing a board of directors comprising at least seven members.

10. The method recited in claim 9, wherein the board of directors consists of seven members.

11. The method recited in claim 1, wherein organizing the at least one franchise bank includes establishing an advisory board of at least seven individuals with a majority of the advisory board comprising managing members selected from a group consisting of one or more founding members, one or more representatives of the bank holding company and one or more representatives of the charter bank.

12. The method recited in claim 11, wherein the advisory board consists of seven individuals, the seven individuals consisting of three founding members, one representative of the bank holding company, one representative of the charter bank and two franchise bank members.

13. The method recited in claim 1, wherein the method further includes:
designating at least one management member who contributes capital and engages in management of the bank holding company and the at least one franchise bank;
designating at least one founding member who contributes capital to the bank holding company; and
designating at least one investment member who contributes capital to the bank holding company and makes deposits into an account at the at least one franchise bank.

14. The method recited in claim 1, wherein the at least one franchise bank further comprises at least one franchise founding member who is designated to contribute capital to the bank holding company, to elect board members to the franchise bank, and to vote to distribute profits from the franchise bank.

15. The method recited in claim 1, wherein the at least one franchise bank is designed to accept and service from at least one business member and at least one individual member who are both designated to receive yearly distributions of profits of the at least one franchise bank.

16. The method as recited in claim 1, wherein the at least one franchise bank includes at least two franchise banks located in distinct locales.
